(19) United States
(12) Patent Application Publication
(10) Pub. No.: US 2003/0108710 A1
(43) Pub. Date: Jun. 12, 2003

(54) Articles bearing patterned microstructures and method of making

(75) Inventors: Dennis Joseph Coyle, Clifton Park, NY (US); Kevin P. Capaldo, Mt. Vernon, IN (US); Beth Brister, DE Bergen op Zoom (NL)

Correspondence Address: Robert E. Walter, GE Plastics, One Plastics Avenue, Pittsfield, MA, 01201, US

(73) Assignee: General Electric Company

(21) Appl. No.: 10/217,313

(22) Filed: Aug. 9, 2002

Related U.S. Application Data
(60) Provisional application No. 60/338,176, filed on Dec. 7, 2001.

(51) Int. Cl. B29D 17/00; B29D 11/00

(52) U.S. Cl. 428/64.4; 425/174.4; 425/363; 425/810; 264/1.33; 264/1.38; 264/1.6

(57) ABSTRACT

A method for producing articles bearing patterned microstructures, e.g., optical film, information carrying substrates for optical recording media, etc. includes applying a radiation curable coating material to a surface of a base film substrate, passing the base film substrate and uncured coating through a compression nip defined by a nip roll and a casting drum having pattern master of the microstructures. The method further includes curing the radiation curable coating by directing radiation energy through the base film substrate from the surface opposite the surface having the coating thereon while the coating is in contact with the drum, thus causing microstructure pattern to be replicated in the cured coating layer.

### CROSS-REFERENCE TO RELATED APPLICATIONS

THIS APPLICATION IS RELATED TO AND CLAIMS PRIORITY FROM PROVISIONAL APPLICATION No. 60/338,176 FILED ON Dec. 7, 2001, THE ENTIRE CONTENTS OF WHICH ARE INCORPORATED BY REFERENCE HEREIN.

### BACKGROUND OF THE INVENTION

This invention relates generally to articles, the surfaces of which bearing patterned microstructures, such as optical films, information carrying discs such as optical recording media, e.g. CDs and DVDs.

Information carrying discs such as CD's and DVD's, require microstructures in the form of spiral track of pits or grooves formed into one surface of a plastic disc or substrate, for example, polycarbonate. Information to be stored is encoded in the track of pits or grooves. For example, a CD uses pits to encode the information directly, while a DVD-RW uses a groove containing materials which can be “written” on by a laser. Typically, the initial pit or groove structure is formed into the plastic substrate by an injection molding process. A nickel stamper containing a negative of the track of pits or grooves is mounted on one surface of a disc mold. Plastic is melted in a screw extruder, injected into the mold, cooled, solidified, and removed from the mold. This process is relatively slow and expensive, with one machine producing one or two discs every three to five seconds. Also, it is difficult to produce discs of very low birefringence because stress, and thus birefringence, is inherent in injection molding. The plastic melt solidifies on the walls of the mold as the mold is filled, and then additional plastic material is forced into the cavity to compensate for shrinkage as the disc solidifies.

Other methods of manufacturing articles bearing patterned microstructures include continuous film processes. One difficulty in any film process is achieving replication of the microstructures, i.e., the pits or grooves on CD discs, without causing other problems. For example, U.S. Pat. No. 4,790,893 to Watkins describes an extrusion calendering process where a polymer melt is extruded onto a master, pressure is applied via a second polished roll to ensure replication of the master, after which the polymer solidifies and is separated from the master. The application of pressure causes large stresses to be frozen into the film so that the finished substrate has a high birefringence and is essentially unusable for CD and DVD discs.

Another approach to replicating a master bearing patterned microstructures is embossing of a plastic film where the master and a pre-made plastic film are pressed together to mechanically deform the surface of the film to replicate the master. U.S. Pat. Nos. 5,242,630 and 5,284,435 to Nuij et al. describe a cold deformation process. U.S. Pat. No. 4,615,573 to Gregg, U.S. Pat. No. 6,059,003 to Whittkopf, and U.S. Pat. No. 6,096,247 to Ulsh et al. describe softening the surface of the plastic with heat prior to embossing. U.S. Pat. No. 6,007,888 to Kime describes softening the plastic surface with heat and heating the stamper prior to embossing. U.S. Pat. Nos. 4,363,844 and 4,519,065 to Lewis et al. describe applying and curing a soft embossible coating to the plastic film and then embossing the coated film. These embossing processes also cause large stresses to be frozen into the film so that the finished substrate has a high birefringence it is also difficult to get accurate replication of these small structures

U.S. Pat. No. 4,275,091 to Lippits et al. describes attaching a master to a rigid flat plate, applying a UV curable coating to the master, applying a plastic substrate to spread the coating and form a sandwich, curing the coating by exposure to UV light through the substrate, and peeling the substrate from the master. This process is referred to as the “2P Process” for production of laser video discs. The “2P Process” is a stepwise process and not a continuous process.

U.S. Pat. No. 5,175,030 to Lu et al. discloses a process wherein a master bearing microstructures or grooves is laid on a flat surface, and a bead of UV-curable resin is deposited across one edge of the grooves and at one end of the master. A plastic film, having a clamp fastened at one end of the film, is spread on top of the resin. A roller is brought into contact with the film and rolled across the film, thus advancing the resin bead to fill the grooves. After the resin has been cured by UV radiation, the clamp is lifted to peel the resulting article, a plastic article bearing microstructures on one side.

### SUMMARY OF THE INVENTION

In one aspect, a method for producing information carrying substrates for articles bearing patterned microstructures. The substrates include a base film substrate and a radiation cured coating layer adhered to the base film substrate, and the cured coating layer includes patterned microstructures. The method includes applying a radiation curable, uncured, coating material to a surface of the base film substrate, passing the base film substrate having the uncured coating thereon through a compression nip defined by a nip roll and a casting drum having a negative pattern master of the microstructures. The compression nip applies a sufficient pressure to the uncured coating and the base film substrate to control the thickness of the coating and to press the coating into full dual contact with both the base film substrate and the casting drum to exclude any air between the coating and the drum. The method further includes curing the radiation curable coating by directing radiation energy through the base film substrate from the surface opposite the surface having the coating thereon while the coating is in full contact with the drum to cause the microstructured pattern to be replicated in the cured coating layer.

In another aspect, a system for producing articles bearing patterned microstructures is provided.

### BRIEF DESCRIPTION OF THE DRAWINGS

FIG. 1 is a schematic view of an apparatus used in one embodiment of the present invention.

FIG. 2 is an atomic force microscope image of a DVD spiral groove track.

### DETAILED DESCRIPTION OF THE INVENTION

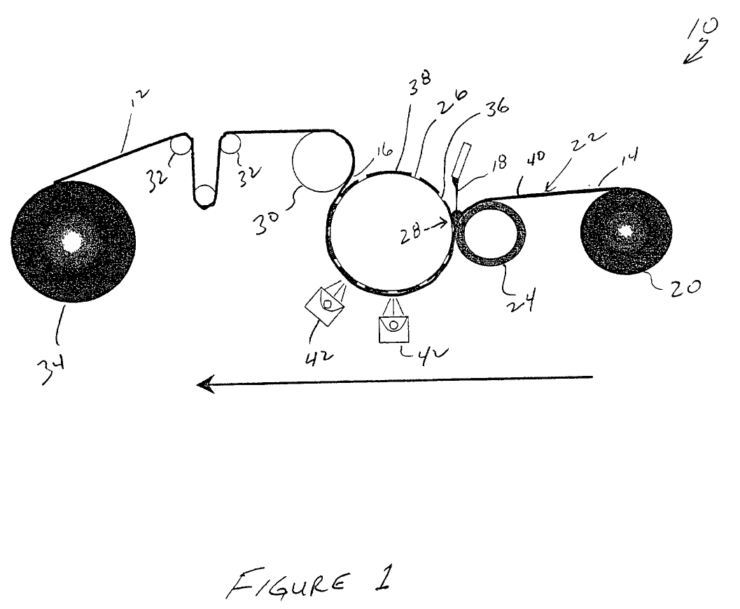

FIG. 1 is a schematic view of an apparatus 10 suitable for manufacturing articles bearing patterned microstructures 12 in accordance with one embodiment of the present invention. The article 12 include a base film substrate 14 and a cured coating layer 16 that is formed by a radiation curable coating 18 and adhered to base film substrate 14. As used herein, the expression “radiation curable” means cure resulting from actinic radiation such as ultraviolet (UV) light, or particle radiation such as an electron beam.

A base film feed or substrate roll 20 includes a continuous web 22 of base film substrate 14. Substrate roll 20 is formed from a roll of uncoated substrate surrounding a core. Web 22 passes between a nip roll 24 and a casting roll 26. The juncture of nip roll 24 and casting roll 26 defines a nip 28. Web 22 extends around casting roll 26 and engages take-off roll 30. A plurality of tension control rolls 32 maintain a surface to surface contact between web 22 and casting roll 26. Web 22 is guided around tension control rolls 32 and then collected on a rewind roll 34.

An outer surface 36 of casting roll 26 includes at least one microstructured master 38 which contains a negative of the patterned microstructures that are to be replicated in cured coating layer 16. In one embodiment, the microstructures 38 are engraved into master, or casting roll surface 36. In another embodiment, the microstructures 38 are individual metal stampers that are attached to casting roll surface 36. In yet another embodiment, casting roll surface 36 is a sheet of thermoplastic resin that has been embossed by a metallic master tool such as nickel-plated copper or brass. Such a thermoplastic master is relatively inexpensive and yet can be used to form a large number of the plastic articles of the invention before becoming unduly worn.

In one embodiment wherein article 12 is an optical film, for example, a brightness enhancement film for use in LCD applications, the patterned microstructures are in a variety of forms. One example of such form is a regular repeating pattern of symmetrical tips and grooves. In another example, the patterns are random and the tips and grooves are not symmetrical, with the size, orientation, shape, or distance between the grooves is not uniform.

In one embodiment wherein article 12 is an optical recording media substrate, each microstructure 38 includes a spiral track of pits or a spiral groove track depending on the type of optical recording media substrate 12 is being used to manufacture. Typically a CD requires a spiral track of pits and a DVD requires a spiral groove track. However, other track patterns can be used for other types of optical recording media.

In another embodiment, article 12 is a having high resolution miniaturized microstructures, adaptable for use in semi-conductor industry, or in bioelectrical applications as microelectrodes.

Radiation curable coating material 18 is applied to a surface 40 of base film substrate 14 upstream of nip 28. Coating 18 can be applied onto surface 40 by any suitable method, for example spraying, brushing, electro-deposition, dipping, flow coating, roll coating, gravure, or screen printing, and can be applied as a continuous coating or as patches that align with pattern masters 38. The coated web 22 then enters nip 28 at the juncture of nip roll 24 and casting roll 26. A controlled nip force ensures that coating 18 makes intimate contact with base film substrate 14 and pattern masters 38 to ensure replication of even sub-micron details of masters 38. Take-off roll 30 ensures that a desired angle of wrap around casting roll 26 is achieved, and thus a controllable time over which the sandwich of base film substrate 14, coating 18, and pattern masters 38 is held under pressure during which coating 18 is cured by directing radiation energy through base film substrate. The pressure is proportional to the web tension, which is controlled by tension control rolls 30. Apparatus 10 includes UV lights 42 positioned adjacent casting roll 26. In one embodiment, an electron beam source is used to supply radiation energy for curing coating 18.

In one embodiment, in order to ensure the exclusion of entrapped air, air pockets, etc., from and adjacent to coating 18 prior to curing, without the use of a nitrogen gas blanket, the nip is carefully adjusted. The exact force that needs to be be exerted at nip 28 will depend on many factors, e.g., the viscosity of coating 18, the degree of detail in the design pattern on pattern masters 38, and the thickness of coating 18. In one embodiment for a substrate having a thickness of 5 mils, having applied thereon an acrylic-based coating having a thickness of 0.6 mil and a viscosity of 800 centipoises, applied at a speed of 40 feet per minute, and using a nip roller with an elastomeric cover of 90 durometer (Shore A hardness), a nip pressure of 25 pounds/linear inch [Crouch uses PSI—and not PLI—yes, but that is technically meaningless because it refers to the air pressure applied to cylinders—the force the coating actually sees can be anything, depending on the diameter of the cylinders, the lever arm, and the coater width!] applied to the coated substrate is used to expel air which is within coating 18 and which is between coating 18 and casting roll 26. Coating 18 is thereby pressed into full contact with both substrate 14 and casting drum surface 26, thereby ensuring that the coating, when cured, will exhibit strong adherence to substrate 14 while also exhibiting a mirror image of the microstructure pattern on casting drum surface.

The nip force is controlled in one embodiment; from about 1 to about 200 pounds per linear inch (pli), and in another embodiment, from about 10 to about 100 pli. Web speeds can vary in one embodiment from about 1 to about 500 feet per minute, and in another embodiment, from about 10 to about 200 feet per minute.

After substrate 14 having coating 18 applied thereon passes through air expulsion nip 28, the coating is cured by means of radiant energy. The choice of a radiant energy source will depend upon several factors, including the chemical nature of the substrate as well as the chemical nature of the coating material being cured. It is important to select a radiant energy source which will not adversely affect substrate 14, e.g. by causing discoloration of the substrate. In one embodiment and as shown in FIG. 1, radiant energy is transmitted from UV lights means 42 into the surface of substrate 14 opposite the surface having coating 10 thereon, i.e., the bottom surface of substrate 14. The radiant energy passes through the transparent substrate and is absorbed by the coating, the latter being compressed between substrate 14 and casting drum surface 26. In one embodiment, the wavelength of the UV radiation is from about 1800 Angstroms to about 4000 Angstroms. The lamp system used to generate such UV radiation may consist of discharge lamps, e.g. xenon, metallic halide, metallic arc, or high, medium, or low pressure mercury vapor discharge lamps, etc., each having operating pressures of from as low as a few milli-torrs up to about 10 atmospheres. The radiation dose level applied to coating 18 through substrate 14 may range from about 2.0 J/cm.sup.2 to about 10.0 J/cm.sup.2. The intensity of the radiation should be selected such that it completely cures the coating compostiion at an economical production rate. When the depth of the microstructure pattern is close to 0.025 mm and the resin contains primarily acrylate functionality, it is possible to complete the curing in less than one second. while keeping the temperature of the curing composition below 50° C. Greater depths of the microstructure or other resin chemistries might require longer times of exposure to complete the cure. Since the cure is accomplished while the coating is sandwiched against the metal drum, the temperature of the cure is simply controlled by controlling the drum temperature by any conventional means such as circulating temperature-contolled water or oil through the drum.

A typical UV curing system suitable for the present invention is a Linde medium pressure mercury lamp. The number of lamps directing UV light to the surface of the substrate is not critical. However, a greater number of lamps may allow a higher production rate for the substrate having coating 18 thereon. Typically, two lamps, each producing 200 watts/linear inch of radiant energy, are sufficient for an acrylic-based coating having a thickness of about 0.5 mils, when the production line speed is about 50 feet/minute. Higher energy lamps permit faster production speeds or slower-curing chemistries.

Depending on the application, the substrate, and the coating systems used, different forms of radiant energy may be used, including electron beam curing, gamma ray curing, infrared curing, and curing methods which use visible wavelengths of light. In certain instances it may be desirable to provide additional lamps adjacent lamps 24 to emit a form of radiant energy suitable for curing coatings on other types of substrates or to fine-tune the degree of cure of the coating. Furthermore, additional lamps may be selectively activated when a different type of coating is being cured.

In one embodiment, while the coating compostion is polymerized by radiation, the temperature is controlled in any of a number of ways, e.g., by passing the radiation throught a heat filter, by cooling the air adjacent to the curing resin, by cooling the casting drum by a suitable heat exchange medium, by cooling the curing composition before applying onto the substrate.

The article of the present invention is characterized by a flexible substrate having at least one face of the substrate bearing patterned microstructures. The thickness of cured coating layer 15 varies depending on the final application of the article and the physical properties desired of the article.

In one embodiment, the thickness of cured coating layer 16 is set to be dependent on the viscosity of coating 18, nip pressure, web speed, temperature, and roll diameters, which can all be controlled to precisely control the thickness of cured coating layer 16. The thickness of cured coating layer 16 is controlled in one embodiment to be about 0.1 to about 100 micrometers, in another embodiment about 1 to about 50 micrometers.

Depending on the final application, the composition of base film substrate 14 can include, for example, metal, paper, acrylics, polycarbonates, phenolics, cellulose acetate butyrate, cellulose acetate propionate, poly(ether sulfone), poly(methyl methacrylate), polyurethane, polyester, poly(vinylchloride), polyethylene terephthalate, etc., or mixtures thereof. The surface of any such substrates may first be treated to promote adhesion to the oligomeric resin. The only restriction on the choice of base film substrate 14 is that it be flexible and capable of allowing the passage of at least one form of radiant energy therethrough, and that its properties not be unacceptably affected by such passage of radiant energy. The radiant energy source is selected to operate at a frequency at which there is little or no absorption of the energy by base film substrate 14.

In one embodiment, base film substrate 14 formed from a thermoplastic polycarbonate material, such as Lexan® resin, commercially available from General Electric Company, Schenectady, N.Y. The thermoplastic polycarbonate resins that may be employed in producing base film substrate 14, include without limitation, aromatic polycarbonates, copolymers of an aromatic polycarbonate such as polyester carbonate copolymer, blends thereof, and blends thereof with other polymers depending on the end use application. In another embodiment, the thermoplastic polycarbonate resin is an aromatic homo-polycarbonate resin and examples of such polycarbonate resins are described in U.S. Pat. No. 4,351,920. They are obtained by the reaction of an aromatic dihydroxy compound with a carbonyl chloride. Other polycarbonate resins may be obtained by the reaction of an aromatic dihydroxy compound with a carbonate precursor such as a diaryl carbonate. A preferred aromatic dihydroxy compound is 2,2-bis(4-hydroxy phenyl) propane (i.e. Bisphenol-A). A polyester carbonate copolymer is obtained by the reaction of a dihydroxy phenol, a carbonate precursor and dicarboxylic acid such as terephthalic acid or isophthalic acid or a mixture of terephthalic and isophthalic acid. Optionally, an amount of a glycol may also be used as a reactant.

In yet another embodiment for optical film applications, polyethylene terephthalate based materials having good optical qualities and acceptable adhesion are used. Examples of such polyethylene terephthalate based materials include: a photograde polyethylene terephthalate; a polyethylene terephthalate (PET) film under the trade name MELINEX PET manufactured by ICI Films of Wilmington, Del.

Radiation-curable coating 18 may comprise a wide variety of compositions. The choice of a particular coating will depend on several factors, such as the type of substrate used, the particular type of radiant energy applied, the particular physical properties desired for the coating, and the particular physical properties desired for the application of the article bearing patterned microstructures. Radiation-curable coating 18 can include polymers containing acrylic, methacrylic or fumaric vinyl unsaturation along or attached to the polymer backbone.

Radiation curable coating 18 is of relatively low viscosity, in the range of 1-10,000 centipoise (cPs). In one embodiment of articles for use in optical applications, the viscosity of the radiation-curable coating 18 is in the range of about 1000-5000 cPs. If the coating has a viscosity above this range, air bubbles may become entrapped in the coating composition. Additionally, the composition may not completely fill the microstructure cavities in the pattern master. If the viscosity is too low, the coating may shrink upon curing that prevents the accurate replicating of the microstructure pattern.

Coating 18 can also include monomers having a molecular weight of from about 100 to 500, and having single unsaturation sites. Typical of these are high boiling acrylate esters, although styrene may also be used as a monomer in selected formulations. A cross-linking oligomer containing di-, tri-, or multifunctional unsaturation sites, for example, oligomeric acrylates. Suitable oligomeric acrylates include, but are not limited to urethane modified acrylate oligomers, polyester modified acrylate oligomers, epoxy modified acrylate oligomers, silicone modified acrylate oligomers, and mixtures thereof.

Radiation-curable coating 18 can also include monomeric and dimeric acrylates, for example, cyclopentyl methacryl ate, cyclohexyl methacryl ate, methylcyclohexylmethacrylate, trimethylcyclohexyl methacrylate, norbornylmethacrylate, norbornylmethyl methacrylate, isobornyl methacrylate, lauryl methacrylate 2-ethylhexyl methacrylate, 2-hydroxyethyl methacrylate, hydroxypropyl acrylate, hexanediol acrylate, 2-phenoxyethyl acrylate, 2-hydroxyethyl acrylate, 2-hydoxypropyl acrylate, diethyleneglycol acrylate, hexanediol methacrylate, 2-phenoxyethyl methacrylate, 2-hydroxyethyl methacrylate, 2-hydoxypropyl methacrylate, diethyleneglycol methacrylate, ethylene glycol dimethacrylate, ethylene glycol diacrylate, propylene glycol dimethacrylate, propylene glycol diacrylate, allyl methacrylate, allyl acrylate, butanediol diacrylate, butanediol dimethacrylate, 1,6hexanediol diacrylate, 1,6-hexanediol dimethacrylate, diethyleneglycol diacrylate, trimethylpropane triacrylate, pentaeryritol tetraacrylate, hexanediol dimethacrylate, diethyleneglycol dimethacrylate, trimethylolpropane triacrylate, trimethylpropane trimethacrylate, pentaeryritol tetramethacrylate, and mixtures thereof.

Radiation curable coating 18 can contain a photosensitizing amount of a photoinitiator, i.e., an amount effective to effect the photocure in air or an inert atmosphere, for example, nitrogen, of the coating composition. In one embodiment, this amount is from about 0.1 parts to about 10 parts by weight, and in another embodiment from about 0.5 parts to about 5 parts by weight of the coating composition. Suitable photoinitiators include, but are not limited to benzophenone and other acetophenones, benzil, benzaldehyde and O-chlorobenzaldehyde, xanthone, thioxanthone, 2-chlorothioxanthone, 9,10-phenanthrenenquinone, 9,10-anthraquinone, methylbenzoin ether, ethylbenzoin ether, isopropyl benzoin ether, 1-hydroxycyclohexyphenyl ketone, α,α-diethoxyacetophenone, α,α-dimethoxyacetoophenone, 1-phenyl-,1,2-propanediol-2-o-benzoyl oxime, 2,4,6-trimethylbenzoyldiphenyl phosphine oxide, and, α,α-dimethoxy-α-phenylacetopheone. Photoinitiators with high intensity at long wavelength region (>400 nm) permit sufficient cure even when the coating is cured by UV light passing through an UV absorbing substrate.

Radiation curable coating 18 can also include various additives and fillers, for example, UV stabilizers, silicas, and solvents. Suitable UV stabilizers include, but are not limited to, resorcinol monobenzoate, 2-methyl resorcinol dibenzoate, 4,6-dibenzoyl resorcinol, silanated 4,6-dibenzoyl resorcinol, etc., benzophenones, benzotriazoles, cyanoacrylates, triazines, hindered amine stabilizers, and mixtures thereof. Suitable organic solvents include, but are not limited to, alcohols, for example, any water miscible alcohol, for example, methanol, ethanol, propanol, butanol, etc., or ether alcohols, such as ethoxyethanol, butoxyethanol, methoxypropanol, etc., and mixtures thereof.

Radiation curable coating 18 can further contain flame retardant compounds including non-acrylate, phosphorous chemicals that have both enough solubility and flame retardant properties to be used in curable coating for optical applications such as cyclic phosphonate ester, halogenated phosphate ester, and the like.

When the radiation curable coating 18 is polymerized by radiation, the temperature of the curing process can be controlled in any of a number of ways, e.g., by passing the radiation through a heat filter, by cooling the air adjacent the curing resin, by cooling the mold with a suitable heat exchange medium, by cooling the oligomeric resin composition before application to the mold, by controlling the intensity of radiation, and when employing actinic radiation, by restricting the amount of photoinitiator.

The above described apparatus and method of producing provides an economical means of producing articles bearing patterned microstructures using a continuous film process that ensures replication of all details of the microstructures in the master.

The invention will be further described by reference to the following examples, which are presented for the purpose of illustration only and are not intended to limit the scope of the invention.

### EXAMPLES

The following examples show the preparation articles having patterned microstructures in the form of an information carrying substrate for use in a DVD-RW disc. A nickel DVD pattern master that includes the negative of a spiral groove track of 1.58 micron spacing, 100 nm depth, 430 nm half-depth width, and 31 degree wall angle, is attached to a casting drum in an apparatus identical to apparatus 10 described above. A radiation curable coating is applied to a Lexan® polycarbonate base film substrate. The radiation curable coating includes a mixture of 40 parts hexanedioldiacrylate, 40 parts trimethylpropane triacrylate, 11 parts dipentaerythratolpenta-acrylate, 6 parts cellulose acetate butyrate resin, and 3 parts diethoxyacetophenone photoinitiator.

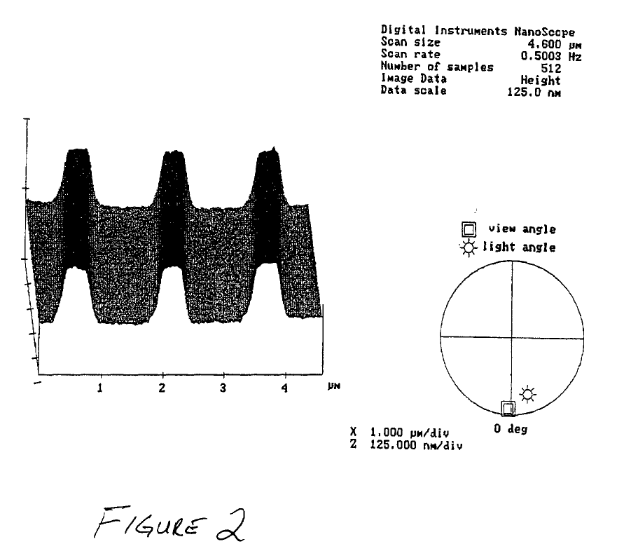

Samples are processed at 5 to 50 feet/minute web speed with between 10 to 50 psi nip pressure. Medium pressure UV arc lamps are used to cure the coating. (Is the conversion from PSI to PLI a standard conversion???) Replication of the DVD spiral groove track is assessed using an atomic force microscope, an image from which appears as FIG. 2. Replication for all samples was exact. One sample is evaluated by processing the sample substrate into a testable DVD-RW. This DVD-RW is successfully cycled through 100 read/write cycles. The following table lists web speed, nip pressure, and film thickness (can be measured by using scanning electron microscope).

| | Web Speed | Nip Pressure | Coating |
|---|---|---|---|
| Sample | (ft/min) | (psi) | Thickness (μm) |
| A | 27 | 35 | 6.6 |
| B | 35 | 35 | 7.9 |
| C | 35 | 35 | 7.9 |
| D | 27 | 35 | 6.6 |
| E | 25 | 10 | 12.9 |
| F | 35 | 50 | 6.4 |
| G | 35 | 25 | 9.6 |
| H | 5 | 10 | 4.1 |
| I | 5 | 10 | 4.1 |
| J | 5 | 40 | 1.8 |
| K | 5 | 40 | 1.8 |
| L | 50 | 40 | 9.4 |
| M | 50 | 40 | 9.4 |

While the invention has been described in terms of various specific embodiments, those skilled in the art will recognize that the invention can be practiced with modification within the spirit and scope of the claims.

What is claimed is:

1. A method for producing an article bearing microstructures, the article comprising a base film substrate and a radiation cured coating layer adhered to the base film substrate, said method comprising:
a) applying a radiation curable, uncured, coating material to a surface of the base film substrate;
b) passing the base film substrate having the uncured coating thereon through a compression nip defined by a nip roll and a casting drum, the casting drum comprising the microstructures, the compression nip applying a sufficient amount of force to the uncured coating and the base film substrate to control the thickness of the coating and to press the coating into full contact with both the base film substrate and the casting drum to exclude any air between the coating and the drum; and
curing the radiation curable coating by directing radiation energy through the base film substrate from the surface opposite the surface having the coating thereon while the coating is in full contact with the drum to cause the microstructures to be replicated in the cured coating layer.

2. A method in accordance with claim 1 wherein the base film substrate comprises polycarbonate.

3. A method in accordance with claim 1 wherein curing the uncured coating by directing radiation energy through the base film substrate comprises curing the uncured coating by directing at least one of UV light radiation and electron beam radiation energy through the base film substrate.

4. A method in accordance with claim 1 wherein the force applied by the compression nip is adjustable and controllable.

5. A method in accordance with claim 4 wherein the nip force is adjustable between about 1 pound per inch to about 200 pounds per inch.

6. A method in accordance with claim 1 wherein the radiation curable coating comprises at least one acrylate resin and a photoinitiator.

7. A method in accordance with claim 6 wherein the radiation curable coating has a viscosity of about 1 centipoise to about 10,000 centipoise.

8. A system for producing information carrying substrates for optical recording media, the information carrying substrate comprising a base film substrate and a radiation cured coating layer adhered to the base film substrate, the cured coating layer comprising at least one information carrying track pattern for optical recording media, said system configured to:
apply a radiation curable, uncured, coating material to a surface of the base film substrate;
pass the base film substrate having the uncured coating thereon through a compression nip defined by a nip roll and a casting drum, the casting drum comprising at least one information carrying track pattern master, the compression nip applying an exact force to the uncured coating and the base film substrate to control the thickness of the coating and to press the coating into full dual anaerobic contact with both the base film substrate and the casting drum to exclude any air between the coating and the drum; and
cure the radiation curable coating by directing radiation energy through the base film substrate from the surface opposite the surface having the coating thereon while the coating is in anaerobic contact with the drum to cause the at least one information carrying track pattern to be replicated the cured coating layer.

9. A system in accordance with claim 8 wherein the base film substrate comprises polycarbonate.

10. A system in accordance with claim 8 wherein said system is configured to cure the radiation curable coating by directing at least one of UV light radiation and electron beam radiation energy through the base film substrate.

11. A system in accordance with claim 8 wherein the force applied by the compression nip is adjustable and controllable.

12. A system in accordance with claim 11 wherein the nip force is adjustable between about 1 pound per inch to about 200 pounds per inch.

13. A system in accordance with claim 8 wherein the radiation curable coating comprises at least one acrylate resin and a photoinitiator.

14. A system in accordance with claim 13 wherein the radiation curable coating has a viscosity of about 1 centipoise to about 10,000 centipoise.

15. Information carrying substrates for optical recording media, said information carrying substrate comprising a base film substrate and a radiation cured coating layer adhered to said base film substrate, said cured coating layer comprising at least one information carrying track pattern for optical recording media, said information carrying substrates produced by a method comprising:
applying a radiation curable, uncured, coating material to a surface of the base film substrate;
passing the base film substrate having the uncured coating thereon through a compression nip defined by a nip roll and a casting drum, the casting drum comprising at least one information carrying track pattern master, the compression nip applying an exact force to the uncured coating and the base film substrate to control the thickness of the coating and to press the coating into full dual anaerobic contact with both the base film substrate and the casting drum to exclude any air between the coating and the drum; and
curing the radiation curable coating by directing radiation energy through the base film substrate from the surface opposite the surface having the coating thereon while the coating is in anaerobic contact with the drum to cause the at least one information carrying track pattern to be replicated in the cured coating layer.

16. Information carrying substrates in accordance with claim 15 wherein the base film substrate comprises polycarbonate.

17. Information carrying substrates in accordance with claim 15 wherein curing the uncured coating by directing radiation energy through the base film substrate comprises curing the uncured coating by directing at least one of UV light radiation and electron beam radiation energy through the base film substrate.

18. Information carrying substrates in accordance with claim 15 wherein the pressure applied by the compression nip is adjustable and controllable.

19. Information carrying substrates in accordance with claim 18 wherein the nip pressure is adjustable between about 1 pound per inch to about 200 pounds per inch.

20. Information carrying substrates in accordance with claim 15 wherein the radiation curable coating comprises at least one acrylate resin and a photoinitiator.

21. Information carrying substrates in accordance with claim 20 wherein the radiation curable coating has a viscosity of about 1 centipoise to about 10,000 centipoise.
